(19) United States
(12) Patent Application Publication
(10) Pub. No.: US 2018/0047006 A1
(43) Pub. Date: Feb. 15, 2018

(54) AUTOMATED STORE RETURN PROCESS

(71) Applicant: Wal-Mart Stores, Inc., Bentonville, AR (US)

(72) Inventors: Christopher Soames Johnson, Pea Ridge, AR (US); Subodh Kumar Pandey, Bentonville, AR (US); Jimmie R. Clark, Fayetteville, AR (US)

(21) Appl. No.: 15/662,456

(22) Filed: Jul. 28, 2017

Related U.S. Application Data
(60) Provisional application No. 62/373,474, filed on Aug. 11, 2016.

(51) Int. Cl. G06Q 20/20; G06Q 30/00; G06Q 10/08; G06F 3/147

(52) U.S. Cl. CPC G06Q 20/208; G06Q 20/201; G06F 3/147; G06Q 30/016; G06Q 10/087; G06Q 10/08; G06K 2017/0051

(57) ABSTRACT

A system and method for returning goods to a retail establishment where the goods were acquired comprises initiating a request to return goods purchased from the retail establishment; positioning the returned goods on a conveyor belt for transport to a location where the goods can be validated; validating the goods by a combination of a validation device proximal the conveyor belt and a return processing system; and generating a refund for the returned goods in response to a positive validation result.

### RELATED APPLICATIONS

This application claims the benefit of U.S. Provisional Patent No. 62/373,474, filed Aug. 11, 2016, entitled “Automated Store Return Process,” the contents of which are incorporated by reference herein in their entirety.

### FIELD

The present concepts relate generally to store returns, and more specifically, to automating a return process that includes validating the returned goods.

### BACKGROUND

A substantial manual effort is generally required when processing store returns in order to reduce theft or fraud. For example, store employees must confirm that a returned store item is indeed the same item that was purchased. Unlawful customers may, for example, may attempt to receive a refund for a television set but returns a box that does not include the purchased television set but instead includes a vintage television set or irrelevant objects such as rocks or bricks, and so on.

### BRIEF SUMMARY

In one aspect, an automated method for returning goods to a retail establishment where the goods were acquired comprises initiating a request to return goods purchased from the retail establishment; positioning the returned goods on a conveyor belt for transport to a location where the goods can be validated; validating the goods by a combination of a validation device proximal the conveyor belt and a return processing system; and generating a refund for the returned goods in response to a positive validation result.

In some embodiments, the method further comprises sensing at an entry to the conveyor belt a presence of a person returning the goods; and authenticating the user.

In some embodiments, initiating the request includes initiating the request at a kiosk.

In some embodiments, validating the goods includes forming a set of checks on the goods.

In some embodiments, the set of checks includes at least one of: weighing the goods using a scale; identifying the goods using an object recognition device; taking an image of the goods in response to generated radiation; and photographing the goods using a camera.

In some embodiments, the method further comprises scanning the goods using a scanning device to determine whether the returned goods are the same as the goods purchased from the retail establishment.

In some embodiments, the refund includes a gift card, a debit to a bank account, an electronic payment, or cash.

In another aspect, a system for returning goods, comprises an automated conveyor belt system for transporting goods purchased from a starting point at a retail establishment and returned to the retail establishment to a location for validating the returned goods; a validation device for analyzing the returned goods and generating a measured input; a return processing system for comparing the measured input and an actual feature of the returned goods; and a kiosk for processing a request to return the goods and for generating a refund in response to a positive validation result generated by the return processing system.

In some embodiments, the system further comprises a computer server for providing data that is output to the validation device for validating the goods.

In some embodiments, the system further comprises a computer server for providing data that is output to the kiosk for generating the refund.

In some embodiments, the automated conveyor belt system directs the goods back to the starting point when the validation device generates a negative validation result.

In some embodiments, the validation device comprises at least one of a scale, an object recognition device, a radiation machine, a camera, and a scanning device.

In some embodiments, the scanning device includes at least one of a radio frequency identification (RFID)/near field communication (NFC) device and a bar code scanner.

In some embodiments, the kiosk generates the refund as a gift card, a debit to a bank account, an electronic payment, or cash.

In some embodiments, the system further comprises a database that stores the actual feature of the returned goods.

In some embodiments, the system further comprises at least one of an item database, a transaction database, a return database, and a gift card database.

In another aspect, a computer-implemented method for returning goods to a retail establishment comprises generating, by a kiosk, an electronic request to return an item purchased from the retail establishment; controlling, by an automated conveyor belt system, a transport of the item to a location for validation; validating, by at least one validation device, the item at a location of the conveyor belt system between a location where the item is deposited onto the conveyor belt system and a return processing system; and automatically generating a refund for the returned item in response to a positive validation result.

In some embodiments, the method further comprises changing a direction of a plurality of segmented belts of the conveyor belt system in response to a negative validation result to transport the item to the location where the item is deposited onto the conveyor belt system.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a schematic illustration of a system for returning store items, in accordance with some embodiments.

FIG. 2 is a flowchart of a method for returning a store item, in accordance with some embodiments.

FIG. 3 is a flow diagram illustrating an automated return operation from a time when a customer arrives at a store to return a previously purchased item to a time of refund, in accordance with some embodiments.

### DETAILED DESCRIPTION

In the following description, specific details are set forth although it should be appreciated by one of ordinary skill in the art that the systems and methods can be practiced without at least some of the details. In some instances, known features or processes are not described in detail so as to not obscure the present invention.

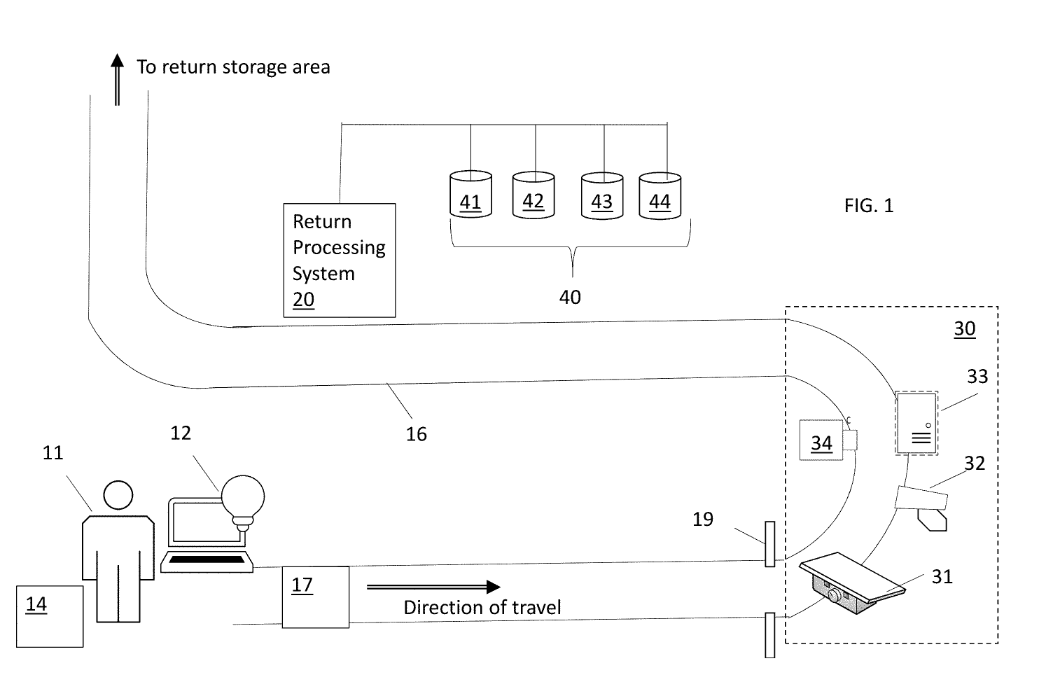

FIG. 1 is a schematic illustration of a system for returning store items, in accordance with some embodiments.

The system may include an automated conveyor belt system 16, a kiosk 12, a presence detector 14, a return processing system 20, and a validation device 30. The system provides a facility setup to both accept returned items and automatically provide refunds for validated return items.

The conveyor belt system 16 is constructed and arranged so that returned store items 17, also referred to as “returns” or “store returns,” may transported from a customer service area to a return storage area. The kiosk 12 and presence detector 14 may be located at the customer service area.

The conveyor belt system 16 may include one or more belted segments between the customer service area and the return storage area that work together to transport the store items 17 from the customer service area to other areas in the store, and include well-known components for performing this function, including but not limited to motors, sensors, guides, rollers, actuators, switches, computer processors, and so on. The belted segments may be synchronized to rotate or otherwise move in a direction toward to the customer service area or the return storage area, depending on an output and processing by a special purpose processor of a control signal that in turn controls the direction of motion of the segments of the conveyor belt system 16. Such control signals may be generated by the kiosk 12, presence detector 14, return processing system 20, and/or validation device 30.

The kiosk 12 or related customer facing electronic device having a display may be at customer service area for use by a retail store customer and/or store associate to initiate a request to return store items 17. The kiosk 12 may also be configured for processing a request to return the goods and for generating a refund in response to a positive validation result generated by one or more validation devices 30.

The kiosk 12 may include a processor, memory, input/output, peripheral devices, such as a display, keyboard, mouse, or may be an interactive device where a user 11 may enter information via the display. The kiosk 12 may communicate with other electronic components of the system via a communications network (not shown), e.g., a wide area network, local area network, wireless network, or a combination thereof, for processing the return merchandise data. The belts of the conveyor belt system 16 may be activated when merchandise return data (barcode, sales slip, etc.) is processed.

The presence detector 14 is positioned at, near, or behind the entrance 19 of the conveyor belt system 16 for sensing an entry or presence of a user 11 returning an item 17, and authenticating the user 11. The presence detector 14 may include a biometric reader, such as a fingerprint scanner. Alternatively, or in addition, the presence detector 14 may include a card reader or the like for reading a credit card, personal identification, store membership card, or other identification that authenticates the user 11.

The validation device 30 is constructed and arranged to validate returned goods 17 on the conveyor belt system 16. The validation device may include but not limited to one or more of a weight scale 31, scanner 32, radiation machine 33, camera 34, and/or other detectors or object recognition devices (not shown). For example, the weight scale 31 may measure a weight of a returned item, and provide a validation result, i.e., a weight value, that is compared to the actual weight of the original item at the time of purchase. Such data on the purchased item may be stored at a store database or other repository and retrieved by the return processing system 20 for comparison to the measured weight value. Any deviation may suggest that the returned item is different than the item that was originally purchased. Similarly, the camera 34 may produce an image of the returned item 17 that may be compared a photograph or other image of the item as originally purchased. The radiation machine 33 may use x-rays, terahertz rays, or the like to produce images of the interior of the packaging, which may be compared to a stored image to determine whether the returned item 17 is valid. The radiation sensing machine may include an x-ray device, terahertz (Tz) device, or related machine that produces radiation at various frequency spectrums. The scanner 32 may read a label, e.g., a barcode or QR code, on the item 17 or its packaging. The scanner device 32 may include at least one of a radio frequency identification (RFID)/near field communication (NFC) device, a bar code or QR scanner, or the like. A combination of these validation devices 30-34 may provide inputs that are compared to actual item information to produce a validation result. A positive validation result indicates that a match is made between a validation device input such as a measured weight of an item analyzed by the weight scale 31, and actual result such as the known weight of the item at the time of purchase. A negative validation result indicates that the weight of the measured item is different than the known weight.

The return processing system 20 receives an input from one or more validation devices 30 that includes a measurement, weight value, image, and so on and compares it to known information of the purchased item, such as the known weight, dimensions, and so on. For example, a purchased television set may have known dimensions, weight, configuration, and so on, and stored at a database 40. This data can be compared to collected data produced by the validation devices 30, such as a measured dimension, weight, and so on, to determine if the collected validation data is the same as the known item data. In some embodiments, the return processing system 20 is part of the validation device 30.

The system may include at least one database 40 in communication with the return processing system 20. Databases 40 may include one or more of an item database 41, a transaction database 42, a return database 43 and a gift card database 44. The item database 41 may include item data, for example, weight, dimensions, barcode data, digital images, and so on. The item data may be organized as records, whereby other information, metatags, or the like can be associated with each item record. For example, an item record may include a location at the store where the item is expected to be stocked, for example, shelf, bin, and aisle number, and/or other breakdown of organization of data.

The transaction database 42 may include purchase transaction data. For example, the return processing system 20 may retrieve information regarding a purchase transaction to compare it to a purchase receipt submitted by a user 11 via the kiosk 12 as evidence of purchase of an item 17 to be returned for authenticity purposes.

The return database 43 may store return data, for example, information regarding a returned item 17, which can be used to provide a refund to the person returning the item. The refund database 44 may store data regarding a refund transaction.

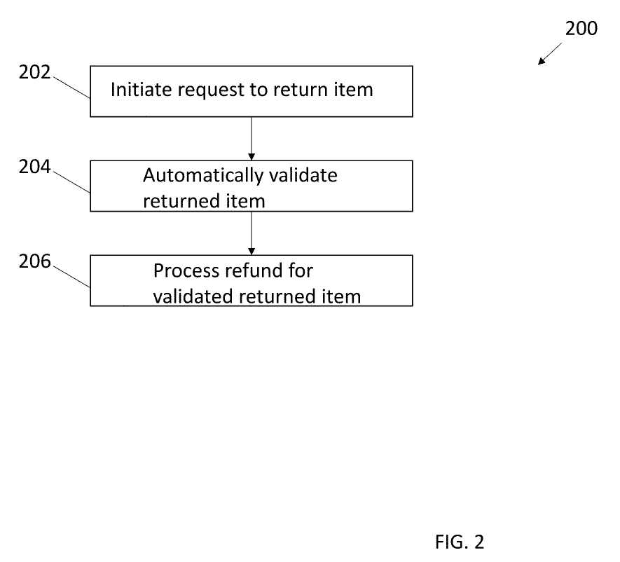

FIG. 2 is a flowchart of a method 200 for returning a store item, in accordance with some embodiments. In describing the method 200, reference is made to elements of the system of FIG. 1. Some or all of the method 200 may be performed by elements of the system of FIG. 1.

At block 202, a request is made to return an item previously purchased at a brick-and-mortar store or online website or other commercial entity. The request is processed electronically by a special purpose computer processor, for example, at a store kiosk 12 shown in FIG. 1.

At block 204, the returned item is automatically validated, by comparing data from one or more validation devices 30 after analyzing the item 17, e.g., camera images, xrays, weight, and so on, with known item information, e.g., the actual weight, dimensions, and so on.

At block 206, a refund is processed in response to a positive validation result generated in response to the comparison performed at block 204.

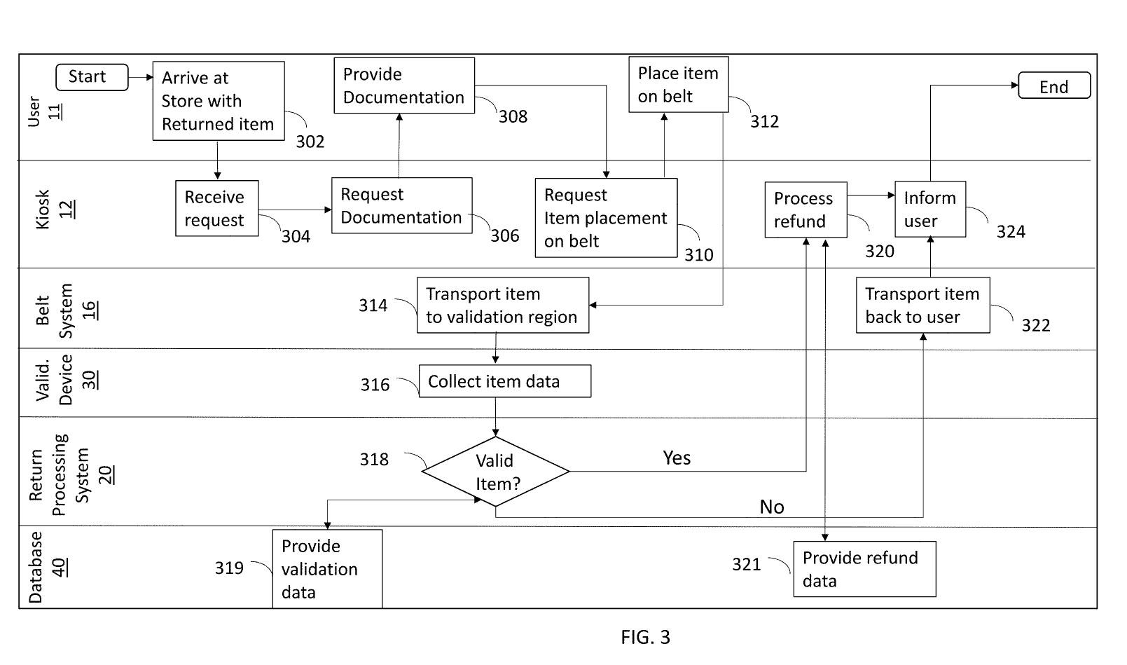

FIG. 3 is a flow diagram illustrating an automated return operation from a time when a customer arrives at a store to return a previously purchased item to a time of refund, in accordance with some embodiments.

At block 302, a user 11 arrives at a store to return an item 17. The user may proceed to a customer service area or other area in accordance with store policy. In doing so, the user 11 may enter a secure area when the customer service area is unmanned. The user 11 may need to enter a passcode, provide a card key, or other authentication information. A presence detector 14 may be at the customer service area for detecting the user 11 and/or authenticating the user 11.

At block 304, a kiosk 12 at a return area may be available for receiving a request from the user 11 to return the item 17. The kiosk 12 may include a display that displays on its screen a questionnaire or other information regarding the store's return policy, etc. The user 11 may use an interactive screen, keyboard, voice activated menu, or other input/output or peripheral device of the kiosk 12 to enter a request.

At block 306, the kiosk 12 may display a request for the user 11 to provide documentation such as a purchase receipt and/or user identification. The kiosk 12 may include a scanner, for example, barcode, optical image, camera, sensor, or the like. At block 308, the user 11 provides the requested documentation using the scanner or the like.

At block 310, the kiosk 12 may display a request for the user 11 to place the returned item 17 on the conveyor belt system 16. At block 312, the user 11 places the item 17 on a belt of the belt system 16.

At block 314, the item 17 is transported by the belt system 16 to a validation region at which the validation device 30 which collects (block 316) data regarding the item 17 which is output to the return processing system 20 for validation.

At decision diamond 318, the return processing system 20 compares a validation result generated by the validation device 30 to actual measurement data regarding the item 17 to determine whether the returned item 17 is the same as the item originally purchased. In doing so, at block 319, the return processing system 20 may search the item database 41 for actual data on the item, for example, weight, dimensions, barcode data, and so on. For example, the actual weight of the item 17 purchased is known to be 30 lbs. The weight scale 31 may weigh the returned item 17 and output the weight value as a validation result. If the weight value is 30 pounds (lbs), then the return processing system 20 may determine that the returned item 17 is valid. The return processing system 20 may receive multiple validation results, for example, a combination of a photograph produced by the camera 34, a result detected and generated by the radiation machine 33, a barcode or QR code result provided by the scanner 32, and so on.

The return processing system 20 may also search (block 319) a transaction database 42 for data regarding the actual purchase. The kiosk 12 may provide the scanned purchase receipt provided by the user 11 to the return processing system 20 which compares it to a record of the purchase stored at the transaction database 42.

In response to a determination that the item 17 is valid, at block 320, the kiosk 12 processes the refund. In doing so, the return processing system 20 may search (block 321) the transaction database 42, a return database 43 and/or gift card database 44 and/or store computer for data regarding a refund. At block 324, the kiosk 12 may inform the user 11 via a display or audio message that the item was validated and that a refund is permitted. The kiosk 12 may also include instructions for the user 11 on how to receive the refund, for example, entering a credit card, receiving a gift card, and so on.

Otherwise, if at decision diamond 318 a determination is made by the return processing system 20 that the item 17 is not valid, then at block 322, the item 17 is returned to the user 11. The conveyor belt may automatically reverse a direction of motion to transport item 17 from the validation region back to customer service desk if the item is not valid At block 324, the kiosk 12 displays an informational message for the user 11, indicating the validation result, namely, that the item failed the validation test.

As will be appreciated by one skilled in the art, concepts may be embodied as a device, system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Computer program code for carrying out operations for the concepts may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Concepts are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While concepts have been shown and described with reference to specific preferred embodiments, it should be understood by those skilled in the art that various changes in form and detail may be made therein without departing from the spirit and scope as defined by the following claims.

What is claimed is:

1. An automated method for returning goods to a retail establishment where the goods were acquired, comprising:
initiating a request to return goods purchased from the retail establishment;
positioning the returned goods on a conveyor belt for transport to a location where the goods can be validated;
validating the goods by a combination of a validation device proximal the conveyor belt and a return processing system; and
generating a refund for the returned goods in response to a positive validation result.

2. The method of claim 1, further comprising:
sensing at an entry to the conveyor belt a presence of a person returning the goods; and
authenticating the user.

3. The method of claim 1, wherein initiating the request includes initiating the request at a kiosk.

4. The method of claim 1, wherein validating the goods includes forming a set of checks on the goods.

5. The method of claim 4, wherein the set of checks includes at least one of:
weighing the goods using a scale;
identifying the goods using an object recognition device;
taking an image of the goods in response to produced radiation; or
photographing the goods using a camera.

6. The method of claim 5, further comprising:
scanning the goods using a scanning device to determine whether the returned goods are the same as the goods purchased from the retail establishment.

7. The method of claim 1, wherein the refund includes a gift card, a debit to a bank account, an electronic payment, or cash.

8. A system for returning goods, comprising:
an automated conveyor belt system for transporting goods purchased from a starting point at a retail establishment and returned to the retail establishment to a location for validating the returned goods;
a validation device for analyzing the returned goods and generating a measured input;
a return processing system for comparing the measured input and an actual feature of the returned goods; and
a kiosk for processing a request to return the goods and for generating a refund in response to a positive validation result generated by the return processing system.

9. The system of claim 8, further comprising a computer server for providing data that is output to the validation device for validating the goods.

10. The system of claim 8, further comprising a computer server for providing data that is output to the kiosk for generating the refund.

11. The system of claim 8, wherein the automated conveyor belt system directs the goods back to the starting point when the validation device generates a negative validation result.

12. The system of claim 8, wherein the validation device comprises at least one of a scale, an object recognition device, a radiation machine, a camera, and a scanning device.

13. The system of claim 12, wherein the scanning device includes at least one of a radio frequency identification (RFID)/near field communication (NFC) device, and a bar code scanner.

14. The system of claim 8, wherein the kiosk generates the refund as a gift card, a debit to a bank account, an electronic payment, or cash.

15. The system of claim 8, further comprising a database that stores the actual feature of the returned goods.

16. The system of claim 8, further comprising at least one of an item database, a transaction database, a return database, and a gift card database.

17. A computer-implemented method for returning goods to a retail establishment, comprising:
generating, by a kiosk, an electronic request to return an item purchased from the retail establishment;
controlling, by an automated conveyor belt system, a transport of the item to a location for validation;
validating, by at least one validation device, the item at a location of the conveyor belt system between a location where the item is deposited onto the conveyor belt system and a return processing system; and
automatically generating a refund for the returned item in response to a positive validation result.

18. The method of claim 17, further comprising:
changing a direction of a plurality of segmented belts of the conveyor belt system in response to a negative validation result to transport the item to the location where the item is deposited onto the conveyor belt system.
